(19) United States
(12) Patent Application Publication
(10) Pub. No.: US 2026/0109264 A1
(43) Pub. Date: Apr. 23, 2026

(54) METHOD AND SYSTEM FOR CONTROLLING CELL BALANCING IN A DUAL BATTERY SYSTEM

(71) Applicants: HYUNDAI MOTOR COMPANY, Seoul (KR); KIA CORPORATION, Seoul (KR)

(72) Inventor: Gee Wook Shin, Hwaseong-si (KR)

(73) Assignees: HYUNDAI MOTOR COMPANY, Seoul (KR); KIA CORPORATION, Seoul (KR)

(21) Appl. No.: 18/967,290

(22) Filed: Dec. 3, 2024

(30) Foreign Application Priority Data
Oct. 17, 2024 (KR) 10-2024-0141952

(51) Int. Cl. B60L 58/22; B60L 50/60; B60L 58/12; B60L 58/16; H01M 10/42; H01M 10/44; H01M 10/46; H02J 7/00; H02J 7/34

(52) U.S. Cl. CPC B60L 58/22; B60L 50/60; B60L 58/12; B60L 58/16; H01M 10/425; H01M 10/441; H01M 10/46; H02J 7/342; H02J 7/855; H01M 2010/4271; H01M 2220/20

(57) ABSTRACT

A cell balancing control method in a dual battery system and a system thereof are provided. The cell balancing control method in a dual battery system uses a sub high voltage battery for stably extending a driving distance in an electric vehicle and may perform cell balancing of a main high voltage battery by using the sub high voltage battery even if there is no separate slow charger in the dual battery system, thereby extending the life of a battery since a current can evenly spread and solidly have energy density when the main high voltage battery is fully charged by slow charging.

### CROSS-REFERENCE TO RELATED APPLICATIONS

The present application claims priority to Korean Patent Application No. 10-2024-0141952, filed on Oct. 17, 2024, the entire contents of which are incorporated herein for all purposes by reference.

### TECHNICAL FIELD

The present disclosure relates to a method and system for controlling cell balancing in a dual battery system of a vehicle and a cell balancing system of the vehicle, more particularly to, cell balancing performed using a sub high voltage battery which may be included to extend a driving distance of the vehicle such as an Electric Vehicle (EV) or a Plug-in Hybrid Electric Vehicle (PHEV).

### BACKGROUND

In general, as shown in FIG. 1, a power system of an EV or a PHEV includes a motor system 14 including a motor 14a configured to generate a driving force and an inverter 14b configured to drive the motor 14a, a main high-voltage battery 11 configured to serve as a power source of the motor 14a, a high-voltage distribution box (hereinafter, referred to as “HV J/BOX”) 12 configured to distribute and supply the high voltage power supplied from the main high-voltage battery 11, and a battery management unit 13 configured to control a power distribution process of the HV J/BOX 12 and manage a state of the main high-voltage battery 11.

The reference numeral 15 refers to a power control unit that performs overall control of the power system.

The power system described above is a concept commonly used by current second-generation electric vehicles.

In the second-generation electric vehicles, the traveling distance per one full charge of the main high-voltage battery 11 is 400 km or longer. The second-generation electric vehicles may satisfy the needs of consumers in the traveling distance to more extent than the first-generation electric vehicles which have a traveling distance of about 200 km per one full charge, however, the improvement is still insufficient to completely satisfy the needs of consumers.

A large-capacity battery such as the main high-voltage battery 11 has a plurality of battery cells therein, and due to imbalance occurring during a manufacturing process or differences in operating conditions, the degree of aging may vary in battery cells over time.

Due to the different aging degrees, some battery cells may be completely discharged while sufficient charge remains in other battery cells.

Then, the completely discharged battery cells cannot supply power any longer, so the capacity of the battery is lowered, which may be evaluated as performance degradation of the battery.

In order to tackle the above technical issue, the battery management unit 13 performs cell balancing to balance a State of Charge (SOC) and/or a cell voltage in-between the plurality of battery cells.

The above-described cell balancing has an effect of maximizing the capacity of the battery and increasing the life of the battery by making all energy of the battery available.

For the safety, the cell balancing is performed in a sleep mode in which the vehicle is not operated. When the vehicle is turned off or not operated, the battery management unit 13 may also enter the sleep mode, but the battery management unit 13 may wake up at a predetermined cycle to perform the cell balancing.

In order for the battery management unit 13 in the sleep mode to wake up every predetermined period, the conventional battery system additionally includes a component for wake-up, such as a real time clock (RTC) integrated circuit (IC), which leads to an increase of the cost and the circuit becoming complicated.

The information included in this Background of the present disclosure section is only for enhancement of understanding of the general background of the present disclosure and may not be taken as an acknowledgement or any form of suggestion that this information forms the prior art already known to a person having ordinary skill in the art.

### SUMMARY

According to an embodiment of the present disclosure, a cell balancing control method for a dual battery system vehicle includes: determining whether cell balancing of a main high voltage battery is required by monitoring a current state of each of at least two battery cells of the main high voltage battery in a start-on state (e.g., vehicle ON state); in response to determining that the cell balancing is required, determining a possibility of performing the cell balancing on the main high voltage battery by using a sub high voltage battery; and in response to determining that the cell balancing is to be performed, charging the main high voltage battery by using the sub high voltage battery as a slow charging power source in response to switching to a parking mode. The dual battery system vehicle includes a motor system configured to drive a motor, the main high voltage battery configured to selectively supply power to the motor system, and the sub high voltage battery configured to selectively supply power to the motor system.

In an embodiment of the present disclosure, the current state may include a state of charge (SOC) and a state of health (SOH) of each of N battery cells constituting the main high voltage battery. N may be an integer greater than or equal to 2.

In an embodiment of the present disclosure, determining whether the cell balancing is required may include: checking the SOC and the SOH of each of the N battery cells of the main high-voltage battery to monitor the current state; and comparing an average of the SOC and the SOH of each of the N battery cells checked through the monitoring, a difference value from the average, and a maximum difference value between the battery cells with a preset threshold range.

In an embodiment of the present disclosure, determining the possibility of performing the cell balancing may include: checking a driving route to a destination; calculating an expected power consumption based on the driving route; predicting a remaining battery power of the main high-voltage battery at a time of arrival at the destination in response to only the main high-voltage battery being used based on the calculated expected power consumption; and determining whether the predicted remaining battery power of the main high-voltage battery is predicted to be lowered to a preset threshold value or less.

In an embodiment of the present disclosure, the preset threshold may be set to a state of charge (SOC) of 30%.

In an embodiment of the present disclosure, the cell balancing control method may further include determining that a start of cell-balancing is inappropriate in response to the remaining battery power of the main high voltage battery being not predicted to be equal to or less than the SOC of 30% in the checking.

In an embodiment of the present disclosure, the cell balancing control method may further include determining whether the main high-voltage battery can be fully charged up to 100% using a current charge amount of the sub high-voltage battery in response to the remaining battery power of the main high-voltage battery being predicted to be equal to or less than the SOC of 30% in the checking.

In an embodiment of the present disclosure, the cell balancing control method may further include in response to determining that the main high voltage battery can be fully charged up to 100% with the current charge amount of the sub high voltage battery, determining that the cell balancing can be performed, and notifying a passenger (e.g., a driver) of the vehicle of whether to prepare for the cell balancing.

In an embodiment of the present disclosure, the cell balancing control method may further include terminating control for the cell-balancing in response to determining that the passenger has rejected the preparation for the cell-balancing in response to the notification.

In an embodiment of the present disclosure, the cell balancing control method may further include in response to deterring that the passenger approves the preparation for the cell-balancing in response to the notification, lowering the charge amount to the SOC of 30% or less by using only the main high voltage battery.

According to an embodiment of the present disclosure, a cell balancing control system in a dual battery system includes a motor system configured to drive a motor; a main high-voltage battery configured to selectively supply power to the motor system; a sub high-voltage battery configured to selectively supply power to the motor system; a battery management unit configured to sense states of the main high-voltage battery and the sub high-voltage battery in response to a control signal; and a power control unit configured to receive state sensing signals of the main high-voltage battery and the sub high-voltage battery through the battery management unit (e.g., a battery management control module of the battery management unit). The battery management unit and the power control unit are further configured to: check whether cell balancing of the main high-voltage battery is required by monitoring a current state of each of at least two battery cells of the main high-voltage battery in a start-on state; determine a possibility of performing the cell balancing on the main high-voltage battery by using the sub high-voltage battery when it is determined that the cell balancing is required; and when it is determined that the cell balancing is to be performed, charge the main high-voltage battery by using the sub high-voltage battery as a slow charging power source when switching a parking mode.

In an embodiment of the present disclosure, the current state may include a state of charge (SOC) and a state of health (SOH) of each of N battery cells constituting the main high-voltage battery. N may be an integer greater than or equal to 2.

In an embodiment of the present disclosure, the battery management unit may be further configured to: check the SOC and the SOH of each of the N battery cells of the main high-voltage battery, compare an average of the SOC and the SOH of each of the N battery cells, a difference value between the average, and a maximum difference value between the battery cells with a preset threshold range; and determine that cell balancing is required when the difference value is out of the preset threshold range.

In an embodiment of the present disclosure, the battery management system and the power control unit may be further configured to: check a driving route to a destination; calculate an expected power consumption based on the driving route; predict a remaining battery power of the main high voltage battery at a time of arrival at the destination when only the main high voltage battery is used based on the calculated expected power consumption; and determine whether the predicted remaining battery power of the main high voltage battery is predicted to be lowered to a preset threshold value or less to determine the possibility of performing the cell balancing.

In an embodiment of the present disclosure, the preset threshold may be set to a state of charge (SOC) of 30%.

In an embodiment of the present disclosure, the power control unit may be further configured to determine that a start of the cell balancing is inappropriate when the remaining battery power of the main high voltage battery is not predicted to be equal to or less than the SOC of 30%.

In an embodiment of the present disclosure, the battery management unit may be further configured to determine whether the main high voltage battery can be fully charged up to 100% using a current charge amount of the sub high voltage battery when the remaining battery power of the main high voltage battery is predicted to be equal to or less than SOC of 30%.

In an embodiment of the present disclosure, when the battery management unit determines that the main high voltage battery can be fully charged up to 100% based on the current charge amount of the sub high voltage battery, the power control unit may be further configured to determine that the cell balancing is available and notify a passenger (e.g., a driver) of a vehicle of whether to prepare for the cell balancing.

In an embodiment of the present disclosure, the power control unit may be further configured to terminate control for the cell-balancing when it is determined that the passenger has rejected the preparation for the cell balancing in response to the notification.

In an embodiment of the present disclosure, the power control unit may be further configured to lower the charge amount to the SOC of 30% or less by using only the main high-voltage battery when it is determined that the passenger approves the preparation for the cell-balancing in response to the notification.

According to an embodiment of the present disclosure, a cell balancing control method in a dual battery system and a system thereof may perform cell balancing of a main high voltage battery by using a sub high voltage battery even if there is no separate slow charger in a dual battery system which uses the sub high voltage battery to extend a driving distance in an electric vehicle such as an EV (Electric Vehicle) or an PHEV (Plug-in Hybrid Electric Vehicle), thereby extending a battery life by uniformly spreading a current and solidly obtaining an energy density when the main high voltage battery is fully charged with slow charging.

The methods, apparatuses, and systems of the present disclosure may have other features and advantages which should be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram for describing a power system of a general electric vehicle.

FIG. 2 is a block diagram of a dual battery system with a sub high voltage battery according to an embodiment of the present disclosure.

FIG. 3 is a block diagram of a dual battery system with a sub high voltage battery according to another embodiment of the present disclosure.

FIGS. 4-5 are detailed block diagrams of parts of the configuration of FIG. 3

FIG. 6 is a flow diagram illustrating a cell balancing control method in a dual battery system according to an embodiment of the present disclosure.

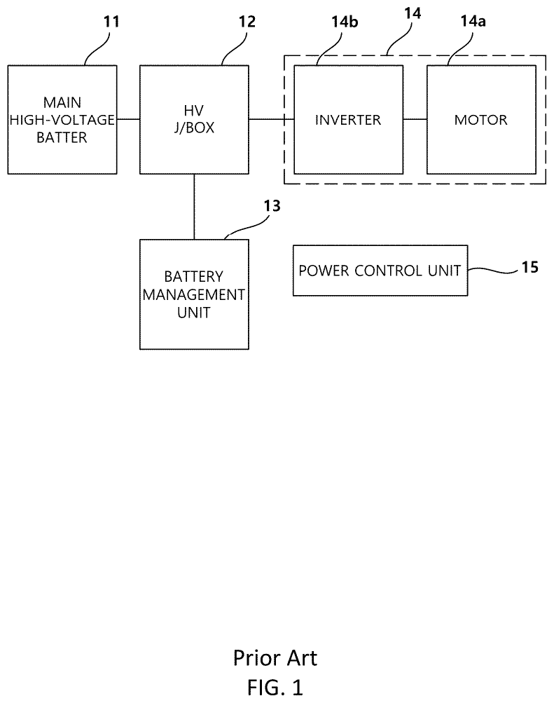

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment. The drawings described herein are for illustration purposes only and are not intended to limit the scope of the present disclosure in any way.

In the figures, the same reference numerals refer to the same or equivalent parts of the present disclosure throughout the several figures of the drawing.

### DETAILED DESCRIPTION

While embodiments are described with reference to the accompanying drawings, it should be understood that various changes and modifications may be made in other embodiments of the present disclosure. Further, it should be understood that the present disclosure is not necessarily limited to the specific embodiments thereof, and various changes, equivalences, and substitutions may be made without departing from the scopes and spirit of the present disclosure.

In the example embodiments of the present disclosure, terms such as “module”, “unit”, “part”, and the like, can be used for nominal distinct between components, and should not necessarily be interpreted as assuming that they are physically and chemically separated or capable of being separated or divided.

Terms containing ordinal numbers, such as “first”, “second”, and the like, may be used to describe various components, but such components are not necessarily limited by such terms. Such terms may be used only in a nominal sense to differentiate one component from another component, and their mutual sequential meaning should be understood through the context of the corresponding description.

The term “and/or” can be used to include all instances of any combination of multiple items being the subject. For example, “A and/or B” includes all three cases: “A”, “B”, and “A and B”.

When a component is used to be “coupled” or “connected” to another component, it can be understood that the component may be either connected directly to another component, or connected indirectly via another medium and/or intervening component(s).

Terms in the present application can be used to describe an example embodiment and do not intend to necessarily restrict and/or limit the present disclosure. Singular forms may be intended to include plural forms unless the context clearly indicates otherwise. According to an embodiment of the present disclosure, terms such as “include,” “comprise,” or “consist of” are used to designate presence of characteristics, numbers, steps, operations, elements, components, or a combination thereof, and do not foreclose the presence or possibility of addition of one or more other characteristics, numbers, steps, operations, elements, components, or a combination thereof.

Unless otherwise defined, terms used in the present disclosure, including technical or scientific terms, can have a same meaning as generally understood by a person having ordinary skill in the technical field to which the present disclosure pertains. Terms defined in commonly used dictionaries can be interpreted as having a meaning consistent with the meaning in the context of the related technology, and unless clearly defined in this application, should not be interpreted in an ideal or excessively formal sense.

In addition, the terms “unit”, “control unit”, “control device”, or “controller” can be widely used for names of devices that control the corresponding functions, and should not be construed as being generic functional units. For example, devices using such terms may include a communication device that communicates with another controller or sensor to control the corresponding function, a computer-readable recording media that stores operating systems, logic commands, input/output information, and the like, and at least one or more of processor that performs determination, calculation, decision, and the like used to control the corresponding function. When a component, controller, unit, module, device, element, apparatus, or the like of the present disclosure is described as having a purpose or performing an operation, function, or the like, the component, controller, unit, module, device, element, apparatus, or the like should be considered herein as being “configured to” meet that purpose or to perform that operation or function. The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

A processor may include a semiconductor integrated circuit and/or electronic elements that perform at least one or more of comparison, determination, calculation, and decision to achieve a programmed function. For example, a processor may be one or the combination of a computer, a microprocessor, a central processing unit (CPU), an application-specific integrated circuit (ASIC), and electronic circuits (circuitry, logic circuits).

A computer-readable recording medium (or referred to as memory or storage medium) can include all types of storage devices that store data that is read by a computer system. Examples of the computer-readable recording medium may include a memory of flash memory type, hard disk type, micro type, and card type (e.g. Secure Digital Card (SD Card) or eXtream Digital Card (XD Card)), and a memory of Random Access Memory (RAM), Static RAM (SRAM), Read-Only Memory (ROM), Programmable ROM (PROM), Electrically Erasable PROM (EEPROM), and magnetic RAM (MRAM), a magnetic disk, or an optical disk type, or any combination thereof.

The recording medium may be electrically connected to the processor, and the processor may load and record data from the recording medium. The recording medium and the processor may be integrated or physically separated.

Hereinafter, a cell balancing control method in a dual battery system and a system thereof according to the present disclosure are described with reference to the accompanying drawings.

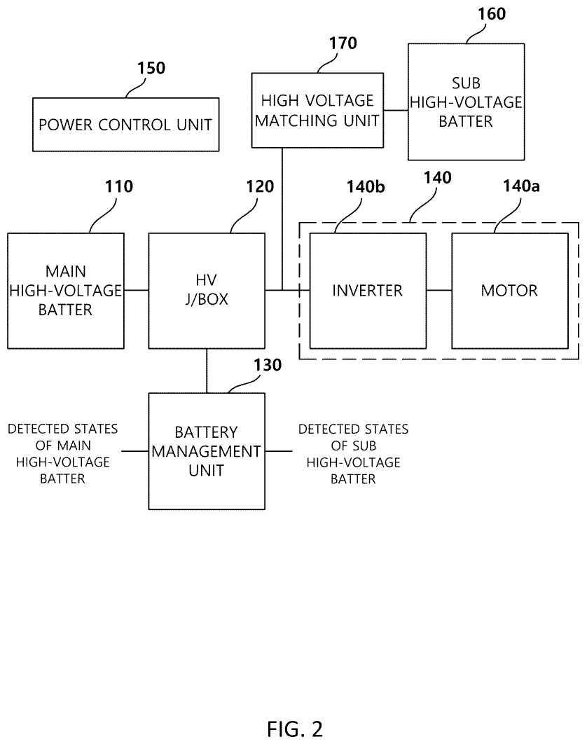

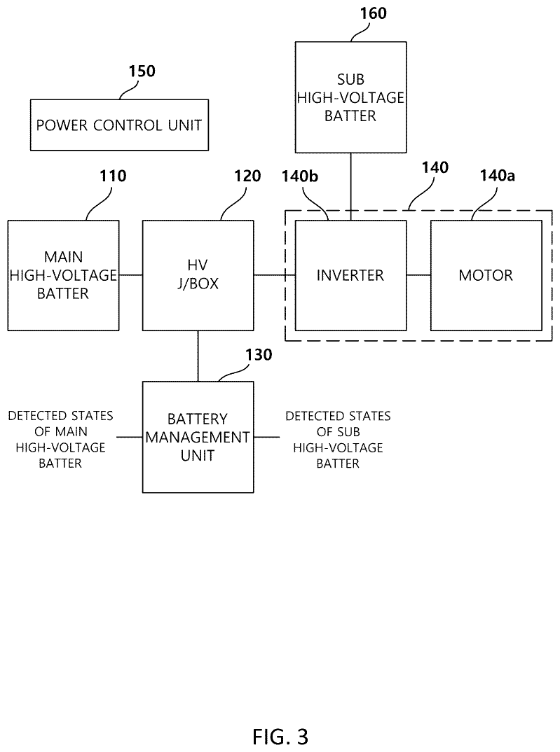

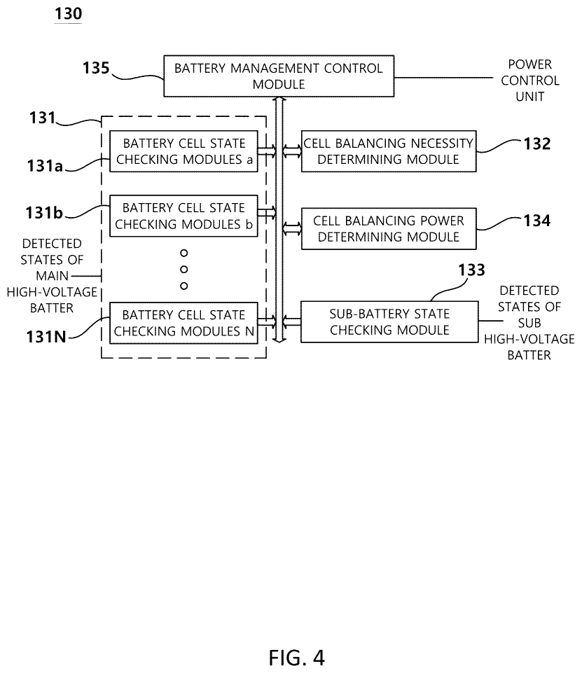

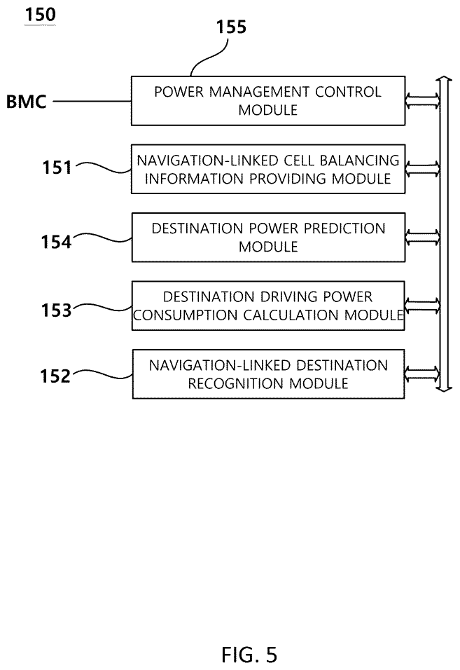

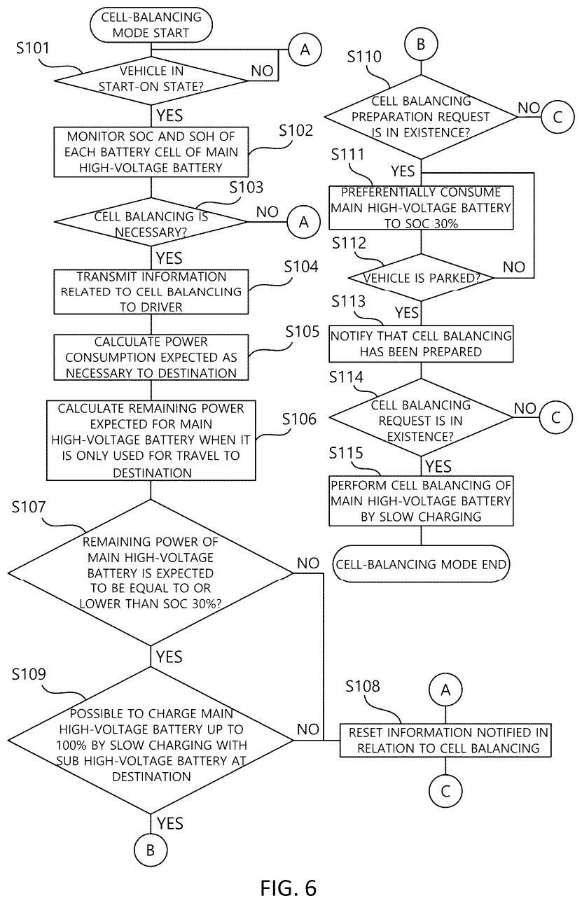

FIG. 2 is a block diagram of a dual battery system having a sub high-voltage battery according to an embodiment of the present disclosure, FIG. 3 is a block diagram of a dual battery system having a sub high-voltage battery according to another embodiment of the present disclosure, FIGS. 4 and 5 are detailed block diagrams of main parts of the configuration of FIG. 3, and FIG. 6 is a flow diagram illustrating a cell balancing control method in a dual battery system according to an embodiment of the present disclosure.

As shown in FIGS. 2 and 3, the dual battery system includes a sub-high voltage battery 160 as well as the components of a motor system 140 including a motor 140a for generating a driving force and an inverter 140b for driving the motor 140a, a main high voltage battery 110 configured to supply power to the motor 140a, a High Voltage Junction Box (hereinafter, referred to as HV J/BOX) 120 for distributing and supplying the high voltage power of the main high voltage battery 110, and a battery management unit 130 configured to control a voltage distribution process of the HV J/BOX 120 and manage a state of the main high voltage battery 110.

In FIG. 2, the reference numeral 150 refers to a power control unit that is configured to perform overall control of the power system.

The main high-voltage battery 110 and the sub-high-voltage battery 160 may be different in capacity and performance.

For example, the main high-voltage battery 110 may have a performance of 123 Kwh (697 volt) and the sub high-voltage battery 160 may have a performance of 30 Kwh (174 volt), which is about 20% to 25% of that of the main high-voltage battery 110.

FIG. 2 shows a case where a converter is required as a high voltage matching unit 170 (e.g., a high voltage DC-DC converter (HDC)) to match the voltages of the main high voltage battery 110 and the sub high voltage battery 160, and FIG. 3 shows a case where the motor system 140 is utilized instead of the additional converter.

In the dual battery system shown in FIG. 2 or 3, the sub high-voltage battery 160 serves to charge the main high-voltage battery 110 or supply auxiliary power to the motor 140a. In addition, the main high-voltage battery 110 can also charge the sub-high-voltage battery 160 as necessary.

In the dual battery system, the sub-high voltage battery 160 can be used as a slow charging power source for cell balancing of the main high voltage battery 110. To this end, as illustrated in FIG. 4, the battery management unit 130 includes a battery cell monitoring module 131 configured to check SOC and SOH states of battery cells of the main high voltage battery 110 in response to a main battery state sensing signal, a cell balancing necessity determining module 132 configured to determine whether cell balancing is necessary based on the states of the battery cells checked by the battery cell monitoring module 131, a sub-battery state checking module 133 configured to check the SOC and SOH states of the sub-high voltage battery 160 based on a sub-battery state sensing signal, a cell balancing power determining module 134 configured to determine a power amount necessary for the cell balancing of the main high voltage battery 110 when the cell balancing necessity determining module 132 determines that the cell balancing is necessary, and a battery management control module 135 configured to notify the power control unit 150 of the determination of the cell balancing necessity determining module 132 that the cell balancing is necessary and to notify the power control unit 150 of a result of determining whether the supplying of the amount of power determined by the cell balancing power determination module 134 is possible based on the SOC and SOH states of the sub-high voltage battery 160 detected by the sub-battery state checking module 133.

The battery cell monitoring module 131 may include N (integer of 2 or greater) battery cell state checking modules 131a to 131N which are associated with the battery cells by one-to-one, wherein each of the battery cell state checking modules 131a to 131N checks the SOC and SOH states of the corresponding battery cell.

The cell balancing necessity determining module 132 compares a difference value between an average of the SOC or SOH values of the battery cells and an SOC or SOH value of one of the battery cells, or the maximum difference value between the SOC or SOH values of the battery cells with a predetermined threshold range, and determines that cell balancing is necessary when the difference value or the maximum difference value is out of the threshold range.

As shown in FIG. 5, the power control unit 150 may include a navigation-linked cell balancing information providing module 151 configured to notify a driver or a passenger of information that cell balancing is required by using a navigation system (not shown) which may operate according to a control signal generated based on a cell balancing necessity determination; a navigation-linked destination recognition module 152 configured to recognize a destination of the vehicle by being linked with the navigation system; a destination driving power consumption calculation module 153 configured to determine power consumption of the main high-voltage battery 110 based on a driving route to the destination; a destination power prediction module 154 configured to predict remaining power of the main high-voltage battery 110 at the arrival at the destination based on the power consumption determined by the destination driving power calculation module 153; and a power management control module 155 configured to control the navigation-linked cell balancing information providing module 151 to notify the necessity of cell balancing to the driver based on a determination that the cell balancing is required by receiving state information of the main high-voltage battery 110 and the sub high-voltage battery 160 through the battery management unit 130, and to connect a discharge path of the sub high-voltage battery 160 and a charge path of the main high-voltage battery 110 to control operations for the cell-balancing through the slow charging of the main high-voltage battery 110 in response to a determination that the cell balancing can be performed through the navigation-linked destination recognition module 152, the destination driving power consumption calculation module 153, and the destination power prediction module 154.

The modules described above may be each implemented as a memory in which a program (computer-readable instructions) for performing a corresponding functionality is stored and a processor for executing the program, the memories of the modules may be integrated into one or more memories, and the processors of the modules may be integrated into one or more processors.

The cell balancing control system in a dual battery system according to the present disclosure performs and controls the cell-balancing of the dual battery system as shown in FIG. 6, wherein the cell balancing is managed by the power control unit 150 shown in FIG. 5 operating in conjunction with the battery management unit 130 shown in FIG. 4.

Briefly describing the method shown in FIG. 6, it includes determining the SOH of each of N (an integer of 2 or greater) battery cells of the main high-voltage battery 110 and performing cell balancing on the N battery cells through slow charging using the sub high-voltage battery 160 as a charging power source when a predetermined condition is satisfied while the vehicle is parked.

In step S101, the power control unit 150 determines whether the vehicle is currently in a start-on state.

When it is determined that the vehicle is turned on in step S101, the process proceeds to step S102, in which the power control unit 150 requests the battery management unit 130 to monitor the SOC and the SOH of each of the N battery cells inside the main high-voltage battery 110, and the battery management unit 130 checks the states of each of the N battery cells through the battery cell monitoring module 131.

Thereafter, the process proceeds to step S103 in which the cell balancing necessity determination module 132 determines whether cell balancing is necessary based on the states of the battery cells in the main high-voltage battery 110 which have been monitored in the process of step S102, and if it is determined that cell balancing is necessary, the battery management control module 135 transfers relevant information to the power management control module 155 in the power control unit 150 in step S104.

The power management control module 155 controls the navigation-linked cell-balancing information providing module 151 based on the information determined by the cell-balancing necessity determining module 132 to transmit the information on the situation of requiring the cell balancing to the driver or the passenger in the process of step S104.

Thereafter, in the process of step S105, the power management control module 155 checks a driving route to the destination via the navigation-linked destination recognition module 152, and provides the driving route to the destination driving power consumption calculation module 153. Then the destination driving power consumption calculation module 153 calculates an estimated power consumption until the vehicle arrives at the destination.

In the process of step S106, the power management control module 155 predicts the remaining battery power of the main high voltage battery 110 when the main high voltage battery 110 is only used for the travel to the destination by the remaining power prediction module 154 based on the expected power consumption amount calculated in the process of step S105.

Then, in the process of step S107, it is determined whether the remaining battery power of the main high voltage battery 110 predicted in the process of step S106 is equal to or less than a preset threshold which may be SOC 30% in an embodiment of the present disclosure.

If it is not predicted that the remaining battery power of the main high voltage battery 110 will be equal to or less than the SOC of 30% in the process of step S107, the process proceeds to step S108 and information of the cell balancing notification including the information transferred in step S104 is reset because it is inappropriate to start the cell balancing.

On the other hand, when it is predicted that the remaining battery power of the main high voltage battery 110 is equal to or less than the SOC 30% in the process of step S107, the process proceeds to step S109 because it is appropriate to start the cell balancing, and in the process of step S109, the power management control module 155 requests the battery management unit 130 to check the state of the sub high voltage battery 160.

Accordingly, the battery management control module 135 of the battery management unit 130 checks the state of the sub-high voltage battery 160 at the current time point via the sub-battery state check module 133, and based on this, transmits to the power management control module 155 information related to a power amount required for the cell balancing which is determined by the cell balancing power determination module 134.

The power management control module 155 finally determines whether the main high-voltage battery 110 can be fully charged up to SOC 100% by the sub-high-voltage battery 160 at the destination.

If it is determined in step S109 that the sub high voltage battery 160 cannot supply the power required for the cell balancing, the process returns to step S108.

On the other hand, if it is determined in step S109 that the sub high voltage battery 160 can supply the power required for the cell balancing, the power management control module 155 determines whether a signal has been generated according to the cell balancing preparation request by the driver or the occupant in step S110.

When it is determined that the cell balancing preparation request is present through the process of step S110, the power of the main high-voltage battery 110 is used until the vehicle is switched from the current traveling state to a parking state (the processes of steps S111 and S112), and thus the remaining power of the main high-voltage battery 110 is preferentially consumed until the remaining power becomes the SOC 30%, which is a predetermined threshold. The cell balancing may start at a SOC level of 20% to 30%, and the threshold is set to 30% in an embodiment.

Thereafter, when it is recognized that the vehicle is parked in step S112, the power management control module 155 proceeds to step S113 and notifies the driver or passenger that the cell balancing preparation is completed via the navigation-linked cell balancing information providing module 151.

In addition, the power management control module 155 determines whether a signal has been generated according to a cell balancing request of the driver or the occupant in step S114.

If it is determined in step S114 that the signal has been generated in accordance with the cell balancing request, the power management control module 155 proceeds to step S115 and connects the discharge path of the sub-high voltage battery 160 with the charge path of the main high voltage battery 110 to slowly charge the main high voltage battery 110 with the power supplied from the sub-high voltage battery 160 until the main high voltage battery 110 is fully charged up to 100%.

Through the above processes, in the dual battery system in which the sub-high voltage battery 160 is used to stably extend the traveling distance of the vehicle, even though there is separately provided no slow charger, the cell balancing of the main high voltage battery 110 may be performed using the sub-high voltage battery 160, such that when the main high voltage battery 110 is fully charged by the slow charging, the current may be evenly spread and the energy density may be firmly obtained, thereby extending the life of the battery.

The foregoing descriptions of specific embodiments of the present disclosure have been presented for purposes of illustration and description. They are not intended to be exhaustive or to limit the present disclosure to the precise forms disclosed, and many modifications and variations are possible in light of the above teachings. The embodiments were chosen and described to explain certain principles of the present disclosure and their practical application, to enable those having ordinary skill in the art to make and utilize various embodiments of the present disclosure, as well as various alternatives and modifications thereof. It is intended that the scope of the present disclosure be defined by the Claims appended hereto and their equivalents.

What is claimed is:

1. A cell balancing control method for a dual battery system vehicle including a motor system configured to drive a motor, a main high voltage battery configured to selectively supply power to the motor system, and a sub high voltage battery configured to selectively supply power to the motor system, the cell balancing control method comprising:
determining whether cell balancing of the main high voltage battery is required by monitoring a current state of each of at least two battery cells of the main high voltage battery in a start-on state to;
in response to determining that the cell balancing is required, determining a possibility of performing the cell balancing on the main high voltage battery by using the sub high voltage battery; and
in response to determining that the cell balancing is to be performed, charging the main high voltage battery by using the sub high voltage battery as a charging power source in response to switching to a parking mode.

2. The cell balancing control method of claim 1, wherein the current state includes a state of charge (SOC) and a state of health (SOH) of each of N battery cells of the main high voltage battery, wherein N is an integer greater than or equal to 2.

3. The cell balancing control method of claim 2, wherein determining whether the cell balancing is required includes:
checking the SOC and the SOH of each of the N battery cells of the main high voltage battery to monitor the current state; and
comparing an average of the SOC and the SOH of each of the N battery cells checked through the monitoring, a difference value from the average, and a maximum difference value between the battery cells with a preset threshold range.

4. The cell balancing control method of claim 1, wherein determining the possibility of performing the cell balancing includes:
checking a driving route to a destination;
calculating an expected power consumption based on the driving route;
predicting a remaining battery power of the main high voltage battery at a time of arrival at the destination in response to only the main high voltage battery being used based on the calculated expected power consumption; and
determining whether the predicted remaining battery power of the main high voltage battery is predicted to be lowered to a preset threshold value or less.

5. The cell balancing control method of claim 4, wherein the preset threshold value is set to a state of charge (SOC) of 30%.

6. The cell balancing control method of claim 5, further comprising determining that a start of cell-balancing is inappropriate in response to the remaining battery power of the main high voltage battery being not predicted to be equal to or less than the SOC of 30% in the checking.

7. The cell balancing control method of claim 5, further comprising: determining whether the main high voltage battery can be fully charged up to 100% using a current charge amount of the sub high voltage battery in response to the remaining battery power of the main high voltage battery being predicted to be equal to or less than the SOC of 30% in the checking.

8. The cell balancing control method of claim 7, further comprising: in response to determining that the main high voltage battery can be fully charged up to 100% with the current charge amount of the sub high voltage battery, determining that the cell balancing can be performed, and notifying a passenger of the vehicle of whether to prepare for the cell balancing.

9. The cell balancing control method of claim 8, further comprising: terminating control for the cell balancing in response to determining that the passenger has rejected the preparation for the cell balancing in response to the notification.

10. The cell balancing control method of claim 9, further comprising: in response to determining that the passenger approves the preparation for the cell balancing in response to the notification, lowering the charge amount to the SOC of 30% or less by using only the main high voltage battery.

11. A cell balancing control system in a dual battery system, the cell balancing control system comprising:
a motor system configured to drive a motor;
a main high voltage battery configured to selectively supply power to the motor system;
a sub high voltage battery configured to selectively supply power to the motor system;
a battery management unit configured to sense states of the main high voltage battery and the sub high voltage battery in response to a control signal; and
a power control unit configured to receive state sensing signals of the main high voltage battery and the sub high voltage battery through the battery management unit,
wherein the battery management unit and the power control unit are further configured to:
check whether cell balancing of the main high voltage battery is required by monitoring a current state of each of at least two battery cells of the main high voltage battery in a start-on state,
determine a possibility of performing the cell balancing on the main high voltage battery by using the sub high voltage battery when it is determined that the cell balancing is required, and
when it is determined that the cell balancing is to be performed, charge the main high voltage battery by using the sub high voltage battery as a charging power source when switching a parking mode.

12. The cell balancing control system of claim 11, wherein the current state includes a state of charge (SOC) and a state of health (SOH) of each of N battery cells constituting the main high voltage battery, wherein N is an integer greater than or equal to 2.

13. The cell balancing control system of claim 12, wherein the battery management unit is further configured to:
check the SOC and the SOH of each of the N battery cells of the main high voltage battery;
compare an average of the SOC and the SOH of each of the N battery cells, a difference value from the average, and a maximum difference value between the battery cells with a preset threshold range; and
determine that cell balancing is required when the difference value is out of the preset threshold range.

14. The cell balancing control system of claim 11, wherein the battery management unit and the power control unit are further configured to:
check a driving route to a destination;
calculate an expected power consumption based on the driving route;
predict a remaining battery power of the main high voltage battery at a time of arrival at the destination when only the main high voltage battery is used based on the calculated expected power consumption; and
determine whether the predicted remaining battery power of the main high voltage battery is predicted to be lowered to a preset threshold value or less to determine the possibility of performing the cell balancing.

15. The cell balancing control system of claim 14, wherein the preset threshold is set to a state of charge (SOC) of 30%.

16. The cell balancing control system of claim 15, wherein the power control unit is further configured to determine that a start of the cell balancing is inappropriate when the remaining battery power of the main high voltage battery is not predicted to be equal to or less than the SOC of 30%.

17. The cell balancing control system of claim 15, wherein the battery management unit is further configured to determine whether the main high voltage battery can be fully charged up to 100% using a current charge amount of the sub high voltage battery when the remaining battery power of the main high voltage battery is predicted to be equal to or less than the SOC of 30%.

18. The cell balancing control system of claim 17, wherein when the battery management unit determines that the main high voltage battery can be fully charged up to 100% based on the current charge amount of the sub high voltage battery, the power control unit is further configured to determine that the cell balancing is available and notify a passenger of a vehicle of whether to prepare for the cell balancing.

19. The cell balancing control system of claim 18, wherein the power control unit is further configured to terminate control for the cell balancing when it is determined that the passenger has rejected the preparation for the cell balancing in response to the notification.

20. The cell balancing control system of claim 19, wherein the power control unit is further configured to lower the charge amount to the SOC of 30% or less by using only the main high voltage battery when it is determined that the passenger approves the preparation for the cell balancing in response to the notification.
